(19) United States
(12) Patent Application Publication
(10) Pub. No.: US 2024/0031946 A1
(43) Pub. Date: Jan. 25, 2024

(54) ANTENNA DEVICE

(71) Applicant: Panasonic Intellectual Property Management Co., Ltd., Osaka (JP)

(72) Inventor: Shigeaki SAKURAZAWA, KANAGAWA KEN (JP)

(73) Assignee: Panasonic Intellectual Property Management Co., Ltd., Osaka (JP)

(21) Appl. No.: 18/222,056

(22) Filed: Jul. 14, 2023

(30) Foreign Application Priority Data
Jul. 20, 2022 (JP) 2022-115266

(51) Int. Cl. H04W 52/28; H04W 28/02

(52) U.S. Cl. CPC H04W 52/285; H04W 28/0226

(57) ABSTRACT

According to one embodiment, an antenna device mounted on a vehicle configured to communicate between the vehicle and another vehicle, between a road and the vehicle, or between a pedestrian and the vehicle using a communication unit including at least one antenna includes a memory and a processor coupled to the memory. The processor is configured to: detect at least one of a traveling place, a traveling state, and a communication history of the vehicle; and set a transmission range of a radio wave transmitted from the antenna based on a detection result.

### CROSS-REFERENCE TO RELATED APPLICATIONS

This application is based upon and claims the benefit of priority from Japanese Patent Application No. 2022-115266, filed on Jul. 20, 2022, the entire contents of which are incorporated herein by reference.

### FIELD

Embodiments described herein relate generally to an antenna device.

### BACKGROUND

In recent years, demand for connected cars has increased, and a V2X (vehicle to X) technology for performing communication between a vehicle and another vehicle, a pedestrian, a roadside unit, or the like has been developed. U.S. Pat. No. 10,567,055 discloses an antenna device including a plurality of antenna units.

U.S. Pat. No. 10,567,055 discloses a technical feature in which an antenna unit close to a base station is operated and an antenna unit far from the base station is not operated. According to the technical feature, by not operating the antenna unit far from the base station, the power consumption of the antenna device can be reduced. However, because a connected car that communicates with another vehicle, a pedestrian, a roadside unit, and the like has a communication counterpart that changes any time, it has been demanded to be able to maintain high communication quality regardless of changes in communication counterpart while reducing power consumption.

### SUMMARY

According to one embodiment, an antenna device mounted on a vehicle configured to communicate between the vehicle and another vehicle, between a road and the vehicle, or between a pedestrian and the vehicle via at least one antenna includes a memory and a processor coupled to the memory. The processor is configured to: detect at least one of a traveling place, a traveling state, and a communication history of the vehicle; and set a transmission range of a radio wave transmitted from the antenna based on a detection result.

### BRIEF DESCRIPTION OF THE DRAWINGS

FIG. 1 is a diagram illustrating an example in which an antenna device according to an embodiment is mounted on a vehicle;

FIG. 2 is a hardware block diagram illustrating an example of a hardware configuration of the antenna device according to the embodiment;

FIG. 3 is a functional block diagram illustrating an example of a functional configuration of the antenna device according to the embodiment;

FIG. 4 is a flowchart illustrating an example of a flow of a process executed by the antenna device according to the embodiment;

FIG. 5 is a first flowchart illustrating an example of a flow of a transmission range setting process executed by the antenna device according to the embodiment;

FIG. 6 is a second flowchart illustrating an example of a flow of a transmission range setting process executed by the antenna device according to the embodiment;

FIG. 7 is a third flowchart illustrating an example of a flow of a transmission range setting process executed by the antenna device according to the embodiment;

FIG. 8 is a fourth flowchart illustrating an example of a flow of a transmission range setting process executed by the antenna device according to the embodiment;

FIG. 9 is a fifth flowchart illustrating an example of a flow of a transmission range setting process executed by the antenna device according to the embodiment; and

FIG. 10 is a flowchart illustrating an example of a flow of a transmission direction setting process executed by the antenna device according to the embodiment.

### DETAILED DESCRIPTION

Hereinafter, an embodiment of an antenna device according to the present disclosure will be described with reference to the accompanying drawings.

Schematic Configuration of Antenna Device

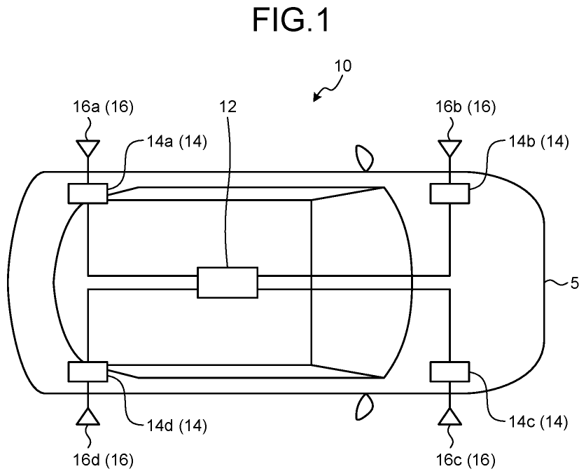

A schematic configuration of an antenna device 10 will be described with reference to FIG. 1. FIG. 1 is a diagram illustrating an example in which the antenna device 10 according to an embodiment is mounted on a vehicle 5.

The antenna device 10 is mounted on the vehicle 5 and includes a central control unit 12 and a plurality of communication units 14a, 14b, 14c, and 14d. Hereinafter, the plurality of communication units 14a, 14b, 14c, and 14d will be collectively referred to as a communication unit 14.

The communication units 14a, 14b, 14c, and 14d include antennas 16a, 16b, 16c, and 16d connected to the communication units 14a, 14b, 14c, and 14d, respectively. Hereinafter, the plurality of antennas 16a, 16b, 16c, and 16d will be collectively referred to as an antenna 16.

The communication unit 14 and the antenna 16 are installed on a roof, trunk lid, or the like of the vehicle 5. The communication unit 14 and the antenna 16 perform wireless communication with another vehicle or a roadside unit that exists with a communication device having a communication function around the vehicle 5, a pedestrian who carries a communication device having a communication function, or a communication network around the vehicle 5. By performing such wireless communication, the vehicle 5 acquires information used for driving assistance and automatic driving. In addition, various kinds of software of the vehicle 5 and various kinds of databases such as map data are updated. In addition, the presence of the vehicle 5 is notified from the vehicle 5 to the outside.

The central control unit 12 acquires an operation state of each unit of the vehicle 5 to detect a state of the vehicle 5. In addition, the central control unit 12 communicates with the communication unit 14 to set a radio wave transmission range and a radio wave transmission direction of the antenna 16 connected to the communication unit 14 according to the state of the vehicle 5 with respect to the communication unit 14. Further, the central control unit 12 acquires a radio wave received by the antenna 16 from the communication unit 14.

In the existing technology, a plurality of communication units 14 and antennas 16 are installed in the vehicle 5, so that the vehicle 5 can communicate with communication equipment in a range as wide as possible. FIG. 1 illustrates an example in which four communication units 14 and four antennas 16 are installed, but the number of communication units/antennas is not limited to four. The places where the communication units 14 and the antennas 16 are installed and the number of communication units/antennas are appropriately determined depending on the vehicle type. Note that, in the antenna device 10, the central control unit 12 and the communication unit 14 may be integrated.

The antenna 16 receives a radio wave related to the V2X application installed on the vehicle 5 from the outside of the vehicle 5, and transmits a radio wave related to the V2X application to the outside of the vehicle 5.

Note that each of the antennas 16 (antennas 16a, 16b, 16c, and 16d) has a structure in which a plurality of antenna elements are arranged in a matrix form. Each antenna element has a so-called beamforming function of receiving a power signal and a phase signal from the outside and setting a radio wave transmission range and a radio wave transmission direction. More specifically, the antenna 16 sets the radio wave transmission range and the radio wave transmission direction by receiving a control signal including a power signal and a phase signal from the central control unit 12 or the communication unit 14, and setting a beam width and a beam direction according to the acquired phase signal. Note that a more detailed description of the beamforming will be omitted, because the beamforming is a known technique widely used for mobile phones and the like.

Hardware Configuration of Antenna Device

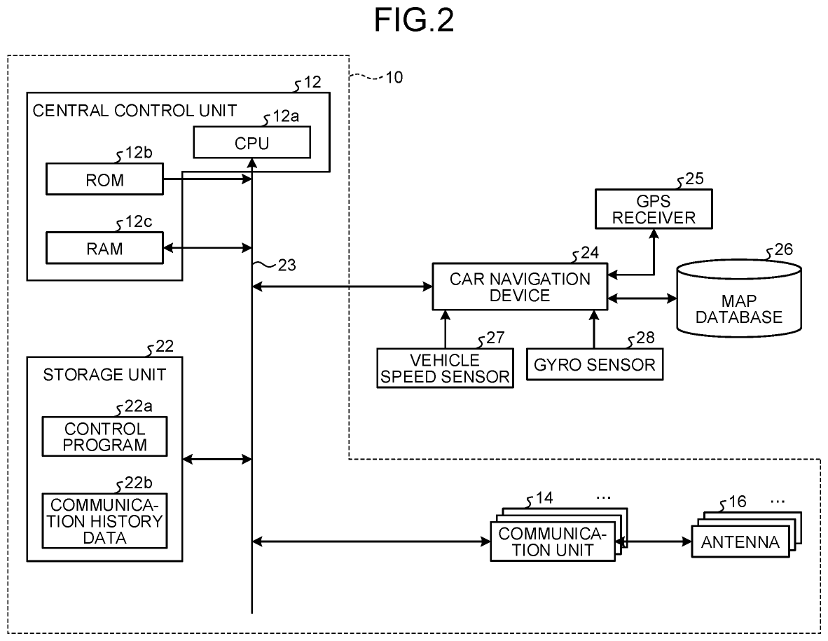

A hardware configuration of the antenna device 10 will be described with reference to FIG. 2. FIG. 2 is a hardware block diagram illustrating an example of a hardware configuration of the antenna device according to the embodiment.

The antenna device 10 includes a central control unit 12 that controls each unit. The central control unit 12 includes a central processing unit (CPU) 12a, a read only memory (ROM) 12b, and a random access memory (RAM) 12c. The CPU 12a is connected to the ROM 12b and the RAM 12c via an internal bus 23 such as an address bus or a data bus. The CPU 12a develops, in the RAM 12c, various programs stored in the ROM 12b and a storage unit 22. The CPU 12a controls the operation of the antenna device 10 by operating according to the various programs developed in the RAM 12c. For example, the central control unit 12 has a computer configuration with existing technology.

The central control unit 12 is connected to the storage unit 22, a car navigation device 24, and the communication unit 14 via the internal bus 23.

The storage unit 22 is a storage device such as a hard disk drive (HDD) or a solid state drive (SSD). Alternatively, the storage unit 22 may be a nonvolatile memory such as a flash memory in which stored information is held even when the power is turned off. The storage unit 22 stores a control program 22a used for causing the antenna device 10 to perform a predetermined operation, and various types of data used for the antenna device 10 to perform various processes, e.g., communication history data 22b.

The communication history data 22b is a data file that stores a history of communication related to the V2X application performed by the vehicle 5 in the past. The communication history data 22b stores a place where communication was performed and radio wave transmission ranges and radio wave transmission directions of the antennas 16a, 16b, 16c, and 16d at that time in association with each other.

The car navigation device 24 measures a current position of the vehicle 5, sets a route to a destination, provides guidance to the route, and the like. A global positioning system (GPS) receiver 25, a map database 26, a vehicle speed sensor 27, and a gyro sensor 28 are connected to the car navigation device 24.

The GPS receiver 25 receives a GPS signal from a GPS satellite.

The map database 26 is a data file in which a road map is stored in such a manner that the car navigation device 24 can measure a current position, search for a route to a destination, and provide guidance to the route.

The vehicle speed sensor 27 detects a vehicle speed of the vehicle 5.

The gyro sensor 28 detects a yaw-direction angular velocity and a pitch-direction angular velocity of the vehicle 5.

Note that the antenna device 10 may omit the car navigation device 24. In a case where the antenna device 10 omits the car navigation device 24, the antenna device 10 may include a configuration that the GPS receiver 25, the map database 26, the vehicle speed sensor 27, and the gyro sensor 28 are connected to the central control unit 12.

As described above, the communication unit 14 is connected to each of the antennas 16. The antenna 16 receives an instruction from the central control unit 12 via the communication unit 14 to set a radio wave transmission range and a radio wave transmission direction. Then, the antenna 16 transmits a radio wave in the set transmission range and in the set transmission direction. The antenna 16 receives a radio wave from the outside of the vehicle 5. The received radio wave is transmitted to the central control unit 12 via the communication unit 14.

Although not illustrated in FIG. 2, the antenna device 10 may obtain image information from a camera mounted on the vehicle 5 to monitor the surroundings of the vehicle 5, and detect environmental information used for setting a radio wave transmission range of the antenna 16 from the image information. Examples of the environmental information used for setting a radio wave transmission range of the antenna 16 include a position of a traveling lane, a shape of the traveling lane, whether there is an intersection, and whether there is a crosswalk.

Functional Configuration of Antenna Device

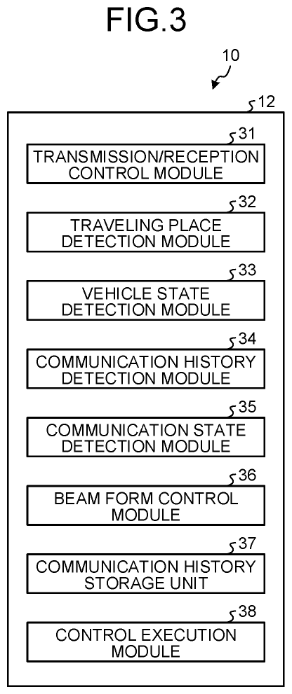

A functional configuration of the antenna device 10 will be described with reference to FIG. 3. FIG. 3 is a functional block diagram illustrating an example of a functional configuration of the antenna device according to the embodiment.

By developing and executing the control program 22a in the RAM 12c, the central control unit 12 of the antenna device 10 implements, as functional units, a transmission/reception control module 31, a traveling place detection module 32, a vehicle state detection module 33, a communication history detection module 34, a communication state detection module 35, a beam form control module 36, a communication history storage unit 37, and a control execution module 38 illustrated in FIG. 3. Some or all of these functions may be implemented by dedicated hardware.

The transmission/reception control module 31 controls reception and transmission of radio waves from and to the antenna 16.

The traveling place detection module 32 detects a traveling place of the vehicle 5. Specifically, the traveling place detection module 32 detects a road type of a road on which the vehicle 5 is traveling on the basis of a current position of the vehicle 5. The road type is, for example, an attribute (a motorway, a general road, or the like) of a road on which the vehicle 5 is traveling.

In addition, the traveling place detection module 32 detects a road line shape or a road incidental item of the road on which the vehicle 5 is traveling. The road line shape refers to, for example, whether there is an intersection, a shape of the intersection, whether there is a diverging/merging lane, a shape of the diverging/merging lane, and whether there is a curve, or a degree of the curve. The road incidental item refers to, for example, whether there is a crosswalk. Note that the traveling place detection module 32 is an example of a first detection module in the present disclosure.

The vehicle state detection module 33 detects a traveling state of the vehicle 5. For example, the vehicle state detection module 33 detects a vehicle speed of the vehicle 5 by reading the output of the vehicle speed sensor 27. In addition, the vehicle state detection module 33 detects whether the vehicle 5 has an inclination in the front-rear direction that does not depend on the road shape, for example, whether the vehicle 5 an inclination in the front-rear direction with respect to the road surface due to the number of occupants, loaded luggage, and the like. In addition, the vehicle state detection module 33 detects whether the vehicle is in a travelable state, for example, based on whether an ignition switch of the vehicle 5 is turned on or whether a main switch of the vehicle 5 is turned on. Note that the vehicle state detection module 33 is an example of a first detection module in the present disclosure.

The communication history detection module 34 detects a communication history of the vehicle 5. Specifically, the communication history detection module 34 refers to the communication history data 22b stored in the storage unit 22 to detect what transmission range the vehicle 5 transmitted a radio wave in when the vehicle 5 transmitted the radio wave in the past at the current position of the vehicle 5. Note that the communication history detection module 34 is an example of a first detection module in the present disclosure.

The communication state detection module 35 detects whether the communication unit 14 has established communication with the outside of the vehicle 5 by the antenna device 10. Note that the communication state detection module 35 is an example of a second detection module in the present disclosure.

The beam form control module 36 sets a transmission range of a radio wave transmitted from the antenna 16 based on at least one of the traveling place of the vehicle 5, the traveling state of the vehicle 5, and the communication history of the vehicle 5. Specifically, the beam form control module 36 sets the transmission range of the radio wave transmitted from the antenna 16 to a range according to the road type of the road on which the vehicle 5 is traveling. For example, the beam form control module 36 sets the transmission range of the radio wave transmitted from the antenna 16 to include at least an area of a lane in which the vehicle 5 is traveling.

When the vehicle speed of the vehicle 5 is equal to or higher than a threshold value, the beam form control module 36 sets the transmission range of the radio wave transmitted from the antenna 16 to be narrower than that when the vehicle speed is lower than the threshold value. In addition, when the inclination of the vehicle 5 in the front-rear direction that does not depend on the road shape is equal to or larger than a predetermined value, the beam form control module 36 sets the transmission range of the radio wave transmitted from the antenna 16 to form a predetermined angle with respect to the road surface of the road on which the vehicle 5 is traveling.

Furthermore, the beam form control module 36 sets the transmission range of the radio wave transmitted from the antenna 16 on the basis of a transmission range of a radio wave when the vehicle 5 has performed communication around the same position in the past. In addition, when the communication state detection module 35 detects that the communication unit 14 of the vehicle 5 has established communication with the outside of the vehicle 5, the beam form control module 36 directs a radio wave transmitted from the antenna 16 to the direction in which the communication has been established.

The communication history storage unit 37 stores, in the storage unit 22, communication history data 22b in which the place where the antenna 16 has transmitted the radio wave is associated with the range in which the radio wave has been transmitted.

The control execution module 38 executes control according to the radio wave received by the antenna 16.

Flow of Process Performed by Antenna Device

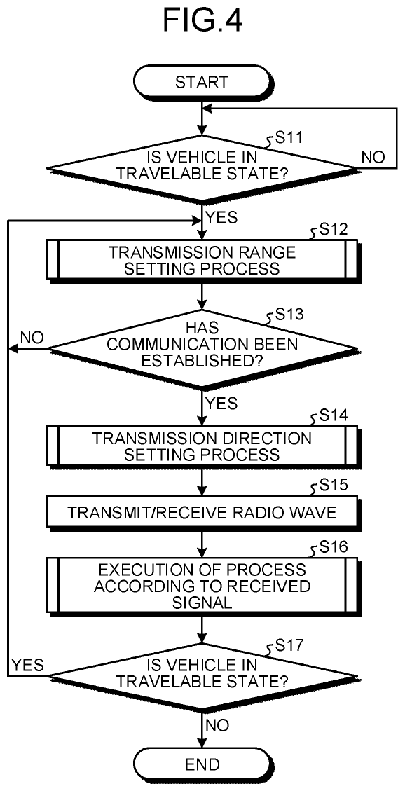

A flow of a process performed by the antenna device 10 will be described with reference to FIG. 4. FIG. 4 is a flowchart illustrating an example of a flow of a process executed by the antenna device according to the embodiment.

The vehicle state detection module 33 determines whether the vehicle 5 is in a travelable state (step S11). When the vehicle 5 is in the travelable state (step S11: Yes), the process proceeds to step S12. On the other hand, when the vehicle 5 is not in the travelable state (step S11: No), step S11 is repeated.

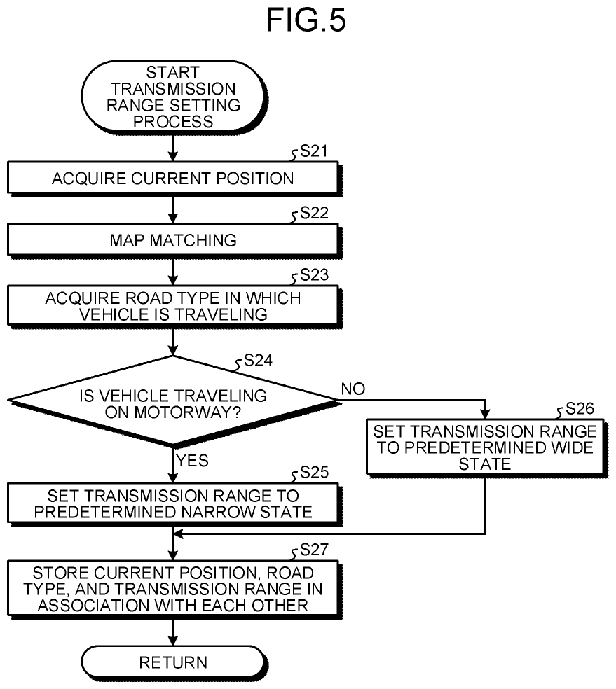

When, in step S11, the vehicle 5 is in the travelable state, the beam form control module 36 performs a transmission range setting process of setting a transmission range of a radio wave transmitted from the antenna 16 (step S12). The transmission range setting process will be described in detail below (see FIGS. 5, 6, 7, 8, and 9).

The communication state detection module 35 determines whether communication has been established by searching for a communication counterpart in the radio wave transmission range set in step S12 (step S13). When communication has been established (step S13: Yes), the process proceeds to step S14. On the other hand, when communication has not been established (step S13: No), the process returns to step S12.

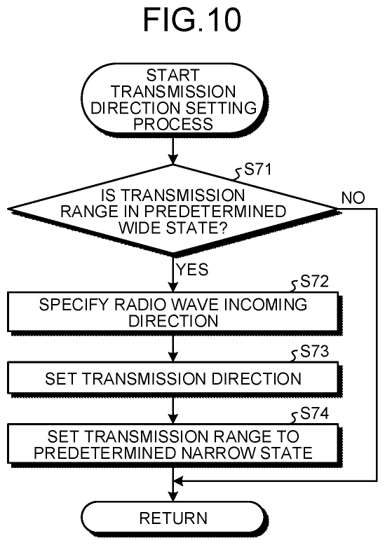

When, in step S13, communication has been established, the beam form control module 36 performs a transmission direction setting process of setting a direction in which a radio wave is transmitted (step S14). The transmission direction setting process will be described in detail below (see FIG. 10). By performing this process, the radio wave transmission range set in step S12 is further narrowed according to the position at which the communication counterpart is present.

The transmission/reception control module 31 transmits/receives a radio wave (step S15).

The control execution module 38 executes control according to the radio wave (received signal) received by the antenna 16 (step S16). The control according to the radio wave received by the antenna 16 is control according to the V2X application installed on the vehicle 5, such as notifying that there is an obstacle, outputting a collision warning, and presenting information regarding a vehicle approaching at the time of lane change.

The vehicle state detection module 33 determines whether the vehicle 5 is in a travelable state (step S17). When the vehicle 5 is in the travelable state (step S17: Yes), the process returns to step S12. On the other hand, when the vehicle 5 is not in the travelable state (step S17: No), the antenna device 10 ends the process of FIG. 4.

First Example of Flow of Transmission Range Setting Process

A first example of a flow of a transmission range setting process performed by the antenna device 10 will be described with reference to FIG. 5. FIG. 5 is a first flowchart illustrating an example of a flow of a transmission range setting process executed by the antenna device according to the embodiment.

In the first example of the transmission range setting process, the radio wave transmission range of the antenna device 10 is set to at least a range of a lane in which a host vehicle is traveling while the host vehicle is traveling on a motorway. It can be assumed that no pedestrian enters the motorway from the side, and the radio wave transmission range may be set to a narrow range.

The traveling place detection module 32 acquires a current position based on a GPS signal received by the GPS receiver 25 from the car navigation device 24 (step S21).

The traveling place detection module 32 reads road map data stored in the map database 26. Then, the traveling place detection module 32 performs map matching between the current position of the vehicle 5 acquired in step S21 and the road map read from the map database 26, thereby specifying a road on which the vehicle 5 is currently traveling (step S22).

The traveling place detection module 32 acquires a road type in which the vehicle is currently traveling from the road map data stored in the map database 26 (step S23).

Subsequently, the traveling place detection module 32 determines whether the road on which the vehicle 5 is traveling is a motorway (step S24). When the road on which the vehicle 5 is traveling is a motorway (step S24: Yes), the process proceeds to step S25. On the other hand, when the road on which the vehicle 5 is not traveling is a motorway (step S24: No), the process proceeds to step S26.

When, in step S24, the road on which the vehicle 5 is traveling is a motorway, the beam form control module 36 sets the transmission range of the antenna 16 to a predetermined narrow state (step S25). The predetermined narrow state is a narrow transmission range determined in advance according to the structure of the antenna, which can be realized by beamforming, and is a range including at least an area of the lane in which the vehicle 5 is traveling. Thereafter, the process proceeds to step S27.

On the other hand, when, in step S24, the road on which the vehicle 5 is not traveling is a motorway, the beam form control module 36 sets the transmission range of the antenna 16 to a predetermined wide state (step S26). The predetermined wide state is a widest transmission range determined in advance according to the structure of the antenna, which can be realized by beamforming. By the processing of step S26, when the vehicle 5 leaves the motorway and enters the general road, the transmission range of the antenna 16 is set to the predetermined wide state. Thereafter, the process proceeds to step S27.

The communication history storage unit 37 stores the current position of the vehicle 5, the road type of the road on which the vehicle 5 is traveling, and the set transmission range of the antenna 16 in association with each other in the communication history data 22b (step S27). Thereafter, the process returns to the main routine of FIG. 4.

As described above, while the vehicle 5 is traveling on the motorway, the transmission range of the antenna 16 is set to a predetermined narrow range, for example, a range including at least a lane in which the vehicle 5 is traveling on the motorway. As a result, the antenna device 10 sets the transmission range of the antenna 16 on the motorway to a range in which a preceding vehicle, which is a main communication counterpart, is present. Note that, in this case, the antenna device 10 may set the transmission range of the antenna 16 to a range including a lane in which the vehicle 5 is traveling and a lane adjacent thereto. As a result, communication can be performed with a vehicle traveling in the adjacent lane as well as the preceding vehicle. By setting the transmission range of the antenna 16 to a narrow range, the power consumption of the antenna device 10 can be reduced.

The antenna device 10 may control the transmission ranges of the antennas 16a and 16d directed rearward of the vehicle 5 among the antennas 16 similarly to the transmission ranges of the antennas 16b and 16c directed forward of the vehicle 5.

Furthermore, as well as setting the radio wave transmission range to the narrow state, the antenna device 10 may increase the power of the radio wave to be transmitted in the narrowly set communication range to set a communication distance to be long. As a result, the antenna device 10 can maintain high communication quality even when the inter-vehicle distance from the preceding vehicle is large.

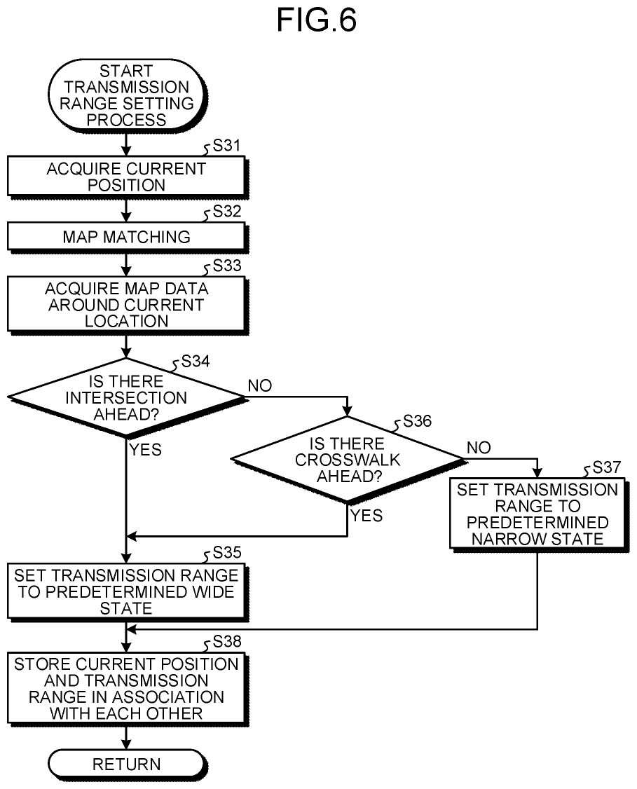

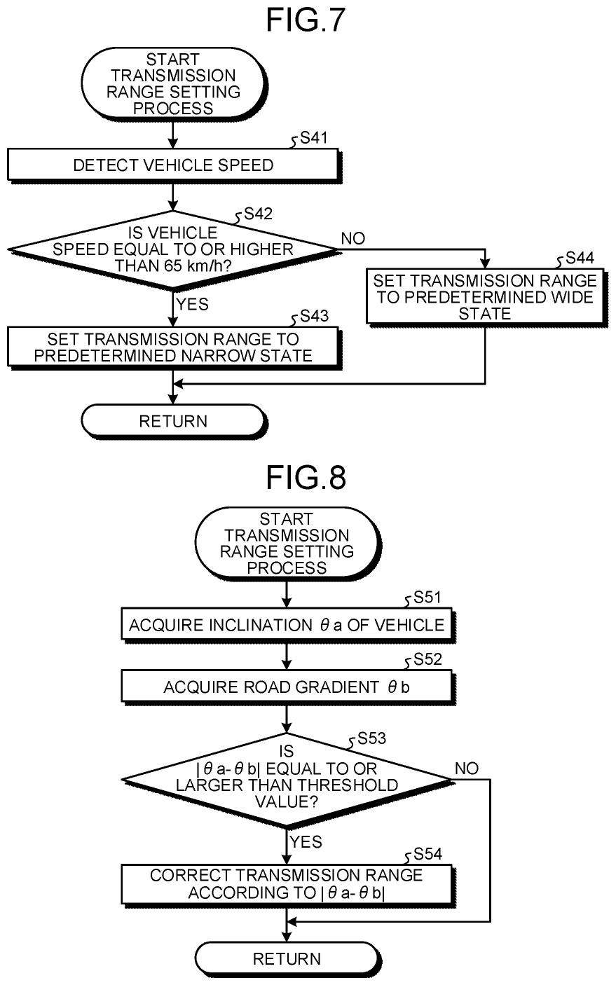

Note that the flow of the process illustrated in FIG. 5 is an example, and in practice, the radio wave transmission range is set according to the content of the V2X application operating in the vehicle 5. For example, the travel of the vehicle 5 on the motorway does not necessarily mean that the radio wave transmission range is narrowed, and the transmission range is set according to the content of the application of V2X operating in the vehicle 5. The same applies to flows of processes illustrated in FIGS. 6 and 7 to be described below.

Second Example of Flow of Transmission Range Setting Process

A second example of a flow of a transmission range setting process performed by the antenna device 10 will be described with reference to FIG. 6. FIG. 6 is a second flowchart illustrating an example of a flow of a transmission range setting process executed by the antenna device according to the embodiment.

In the second example of the transmission range setting process, when there is an intersection or a crosswalk in front of the road on which the vehicle is traveling, the radio wave transmission range of the antenna device 10 is set to a predetermined wide range.

The traveling place detection module 32 acquires a current position based on a GPS signal received by the GPS receiver 25 from the car navigation device 24 (step S31).

The traveling place detection module 32 reads road map data stored in the map database 26. Then, the traveling place detection module 32 performs map matching between the current position of the vehicle 5 acquired in step S31 and the road map read from the map database 26, thereby specifying a road on which the vehicle 5 is currently traveling (step S32).

The traveling place detection module 32 acquires a road line shape or a road attribute in a traveling direction of the vehicle 5 on the road on which the vehicle 5 is currently traveling from the road map data stored in the map database 26 (step S33). The road line shape acquired here refers to, for example, whether there is an intersection, and the road attribute refers to, for example, whether there is a crosswalk.

Subsequently, the traveling place detection module 32 determines whether there is an intersection in the traveling direction of the vehicle 5 (step S34). When there is an intersection in the traveling direction of the vehicle (step S34: Yes), the process proceeds to step S35. On the other hand, when there is not an intersection in the traveling direction of the vehicle 5 (step S34: No), the process proceeds to step S36.

When, in step S34, there is an intersection in the traveling direction of the vehicle 5, the beam form control module 36 sets the transmission range of the antenna 16 to a predetermined wide state (step S35). Thereafter, the process proceeds to step S38.

On the other hand, when, in step S34, there is not an intersection in the traveling direction of the vehicle 5, the traveling place detection module 32 determines whether there is a crosswalk in the traveling direction of the vehicle 5 (step S36). When there is a crosswalk in the traveling direction of the vehicle 5 (step S36: Yes), the process proceeds to step S35. On the other hand, when there is not a crosswalk in the traveling direction of the vehicle (step S36: No), the process proceeds to step S37.

When, in step S36, there is not a crosswalk in the traveling direction of the vehicle 5, the beam form control module 36 sets the transmission range of the antenna 16 to a predetermined narrow state (step S37). Thereafter, the process proceeds to step S38.

The communication history storage unit 37 stores the current position of the vehicle 5 and the set transmission range of the antenna 16 in association with each other in the communication history data 22b (step S38). Thereafter, the process returns to the main routine of FIG. 4.

By setting the transmission range of the antenna 16 to the wide state before the intersection or before the crosswalk as described above, the antenna device 10 can reliably detect that there is a pedestrian near the intersection or the crosswalk and to reliably detect that there is another vehicle crossing the intersection. Then, after confirming that the vehicle has passed the intersection or the crosswalk, the antenna device 10 changes the transmission range of the antenna 16 to a predetermined narrow range.

The antenna device 10 may control the transmission ranges of the antennas 16a and 16d directed rearward of the vehicle 5 among the antennas 16 similarly to the transmission ranges of the antennas 16b and 16c directed forward of the vehicle.

Third Example of Flow of Transmission Range Setting Process

A third example of a flow of a transmission range setting process performed by the antenna device 10 will be described with reference to FIG. 7. FIG. 7 is a third flowchart illustrating an example of a flow of a transmission range setting process executed by the antenna device according to the embodiment.

In the third example of the transmission range setting process, when the vehicle speed of the vehicle 5 is equal to or higher than a threshold value, the radio wave transmission range of the antenna device 10 is set to a predetermined narrow range.

The vehicle state detection module 33 detects a vehicle speed of the vehicle 5 by reading the output of the vehicle speed sensor 27 (step S41).

The vehicle state detection module 33 determines whether the vehicle speed of the vehicle 5 is equal to or higher than 65 km/h (step S42). When the vehicle speed of the vehicle 5 is equal to or higher than 65 km/h (step S42: Yes), the process proceeds to step S43. On the other hand, when the vehicle speed of the vehicle 5 is not equal to or higher than 65 km/h (step S42: No), the process proceeds to step S44. The threshold value of the vehicle speed is not limited to 65 km/h.

When the vehicle state detection module 33 determines in step S42 that the vehicle speed is equal to or higher than 65 km/h, the beam form control module 36 sets the transmission range of the antenna 16 to a predetermined narrow state (step S43). Thereafter, the process returns to the main routine of FIG. 4.

When the vehicle state detection module 33 does not determine in step S42 that the vehicle speed is equal to or higher than 65 km/h, the beam form control module 36 sets the transmission range of the antenna 16 to a predetermined wide state (step S44). Thereafter, the process returns to the main routine of FIG. 4.

When the vehicle speed of the vehicle 5 is equal to or higher than the threshold value as described above, the antenna device 10 can reduce the power consumption of the antenna device 10 by setting the transmission range of the antenna 16 to a narrow state and narrowing down the communication partner of the antenna device 10 during high-speed traveling.

The antenna device 10 may control the transmission ranges of the antennas 16a and 16d directed rearward of the vehicle 5 among the antennas 16 similarly to the transmission ranges of the antennas 16b and 16c directed forward of the vehicle 5.

Fourth Example of Flow of Transmission Range Setting Process

A fourth example of a flow of a transmission range setting process performed by the antenna device 10 will be described with reference to FIG. 8. FIG. 8 is a fourth flowchart illustrating an example of a flow of a transmission range setting process executed by the antenna device according to the embodiment.

The fourth example of the transmission range setting process is an example in which the transmission range of the antenna 16 is corrected in a case where the vehicle 5 is inclined in the front-rear direction due to a factor other than an inclined road. For example, in a case where heavy luggage is loaded on the rear trunk of the vehicle 5, or in a case where there are many occupants on rear seats of the vehicle 5, the rear portion of the vehicle 5 may sink and the front portion of the vehicle body may rise. In such a case, the transmission ranges of the antennas 16b and 16c (see FIG. 1), of which the transmission ranges are directed forward of the vehicle 5 among the antennas 16, are raised with respect to the road surface. On the other hand, the transmission ranges of the antennas 16a and 16d (see FIG. 1), of which the transmission ranges are directed rearward of the vehicle 5 among the antennas 16, are lowered with respect to the road surface. Therefore, since the antenna device 10 may transmit a radio wave to a range different from the predetermined transmission range, the antenna device 10 may correct the transmission ranges of the antenna 16b and the antenna 16c to be lowered, more accurately, to form a predetermined angle with respect to the road surface. In addition, the antenna device 10 may correct the transmission ranges of the antenna 16a and the antenna 16d to be raised, more accurately, to form a predetermined angle with respect to the road surface.

The vehicle state detection module 33 acquires an inclination θa of the vehicle 5 by reading the output of the vehicle speed sensor 27 (step S51). The inclination θa of the vehicle 5 can be detected, for example, based on the output of the gyro sensor 28, the suspension stroke state of each wheel of the vehicle 5, and the like.

For example, the traveling place detection module 32 acquires a road gradient Ob at a current position on the basis of the information of the map database 26 corresponding to the current position of the vehicle 5 subjected to map matching (step S52).

The vehicle state detection module 33 determines whether an inclination |θa-θb| of the vehicle 5 in the front-rear direction that does not depend on the road shape, which is calculated from the inclination θa and the road gradient Ob, is equal to or larger than a threshold value (step S53). When the inclination |θa-θb| is equal to or larger than the threshold value (step S53: Yes), the process proceeds to step S54. On the other hand, when the inclination |θa-θb| is not equal to or larger than the threshold value (step S53: No), the process returns to the main routine of FIG. 4.

When, in step S53, the inclination |θa-θb| is equal to or larger than the threshold value, the beam form control module 36 corrects the transmission range of the antenna 16 according to the inclination |θa-θb| (step S54). Thereafter, the process returns to the main routine of FIG. 4.

In step S54, by correcting the transmission range of the antenna 16 according to the inclination |θa-θb|, the beam form control module 36 sets the transmission range of the antenna 16 to form a predetermined angle with respect to the road surface. More specifically, when the front of the vehicle body is rising, the transmission range of the antenna that transmits a radio wave forward of the vehicle 5 is corrected to be lowered in the vertical direction. In addition, the transmission range of the antenna that transmits a radio wave rearward of the vehicle 5 is corrected to be raised in the vertical direction. On the other hand, when the rear of the vehicle body is rising, the transmission range of the antenna that transmits a radio wave forward of the vehicle 5 is corrected to be raised in the vertical direction. In addition, the transmission range of the antenna that transmits a radio wave rearward of the vehicle 5 is corrected to be lowered in the vertical direction. A correction amount is set to be larger as the inclination |θa-θb| is larger.

By correcting the transmission range of the antenna 16 the inclination |θa-θb| of the vehicle 5 in the front-rear direction that does not depend on the road shape is equal to or greater than the threshold value as described above, the transmission range of the antenna 16 can be set to form a predetermined angle with respect to the road surface regardless of the inclination of the vehicle body in the front-rear direction with respect to the road surface. As a result, the antenna device 10 can stably transmit and receive radio waves regardless of the direction of the vehicle body.

Fifth Example of Flow of Transmission Range Setting Process

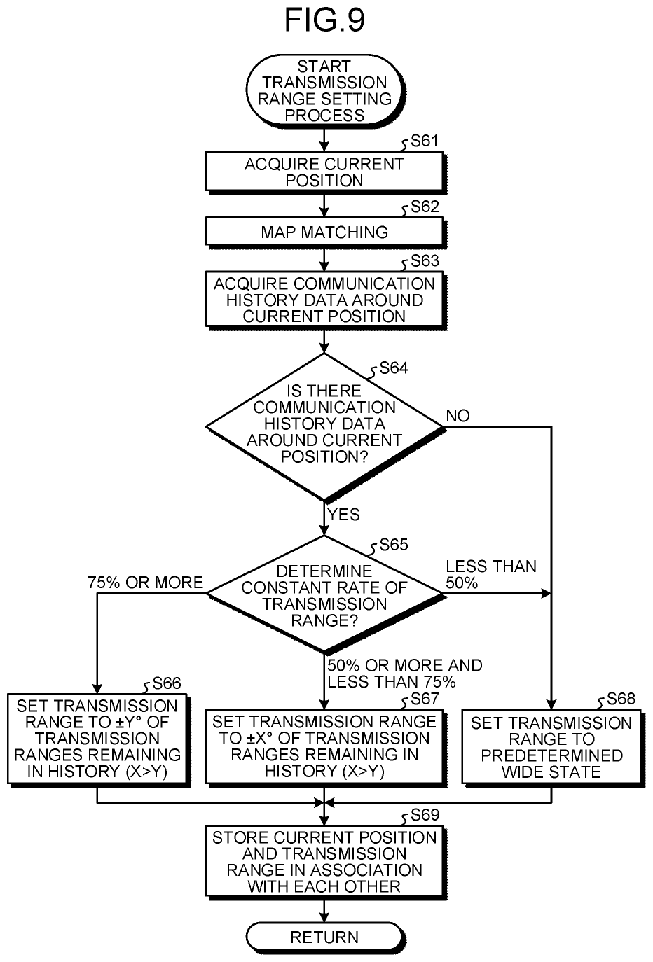

A fifth example of a flow of a transmission range setting process performed by the antenna device 10 will be described with reference to FIG. 9. FIG. 9 is a fifth flowchart illustrating an example of a flow of a transmission range setting process executed by the antenna device according to the embodiment.

The fifth example of the transmission range setting process is an example in which, when the vehicle 5 has traveled at the same position as in the past, a radio wave transmission range is set to be similar to the radio wave transmission range set by the antenna device 10 in the past.

The traveling place detection module 32 acquires a current position based on a GPS signal received by the GPS receiver 25 from the car navigation device 24 (step S61).

The traveling place detection module 32 reads road map data stored in the map database 26. Then, the traveling place detection module 32 performs map matching between the current position of the vehicle 5 acquired in step S61 and the road map read from the map database 26, thereby specifying a road on which the vehicle 5 is currently traveling (step S62).

The communication history detection module 34 acquires communication history data 22b around the current position of the vehicle 5 from the storage unit 22 (step S63).

The communication history detection module 34 determines whether there is communication history data 22b around the current position of the vehicle 5 from the communication history data 22b acquired in step S63 (step S64). When there is communication history data 22b around the current position of the vehicle 5 (step S64: Yes), the process proceeds to step S65. On the other hand, when there is not communication history data 22b around the current position of the vehicle 5 (step S64: No), the process proceeds to step S68.

When, in step S64, there is communication history data 22b around the current position of the vehicle 5, the communication history detection module 34 compares transmission ranges of radio waves transmitted by the antenna 16 in the past around the current position of the vehicle 5, and determines a constant rate of the transmission range (step S65). When the constant rate of the transmission range is 75% or more, the process proceeds to step S66. When the constant rate of the transmission range is 50% or more and less than 75%, the process proceeds to step S67. When the constant rate of the transmission range is less than 50%, the process proceeds to step S68.

When, in step S65, the constant rate of the transmission range is 75% or more, the beam form control module 36 sets the radio wave transmission range to a range of ±Y ° with respect to the transmission ranges remaining in the communication history data 22b (step S66). Thereafter, the process proceeds to step S69.

When, in step S65, the constant rate of the transmission range is 50% or more and less than 75%, the beam form control module 36 sets the radio wave transmission range to a range of ±X ° with respect to the transmission ranges remaining in the communication history data 22b (step S67). Thereafter, the process proceeds to step S69. Note that Y described in step S66 and X described in step S67 have a relationship of X>Y. For example, when the constant rate of the transmission range is high (75% or more), a range obtained by adding a small margin to the average of the past transmission ranges is set as a transmission area. On the other hand, when the constant rate of the transmission range is slightly high (50% or more and less than 75%), a range obtained by adding a larger margin to the average of the past transmission ranges is set as a transmission area.

When, in step S65, the constant rate of the transmission range is less than 50%, the beam form control module 36 sets the transmission range of the antenna 16 to a predetermined wide state (step S68). Thereafter, the process proceeds to step S69.

Subsequent to step S66, step S67, or step S68, the communication history storage unit 37 stores the current position of the vehicle 5 and the set transmission range of the antenna 16 in association with each other in the communication history data 22b (step S69). Note that the transmission range stored in step S69 is a transmission range excluding the margin described above. Thereafter, the process returns to the main routine of FIG. 4.

By referring to the communication history made at the same point in the past as described above, the antenna device 10 may omit the acquisition of a road type, a road line shape, a vehicle state, and the like, and, the antenna device 10 can set a radio wave transmission range in a shorter period time.

Note that the antenna device 10 may set the transmission range for each antenna by storing the communication history data 22b for each of the antennas 16.

Some examples of transmission range setting processes have been described above. In these transmission range setting processes, the beam form control module 36 sets the transmission range of the antenna 16 to either the predetermined narrow state or the predetermined wide state, but the transmission range of the antenna 16 may be set more finely in multiple stages.

Furthermore, in the above-described embodiment, the antenna device 10 may stop the operation of the antenna that transmits a radio wave in a direction in which there is no communication counterpart. As a result, the power consumption of the antenna device 10 can be further reduced.

Further, the transmission range setting processes illustrated in FIGS. 5 to 9 may be executed each independently, or may be executed in any possible combination. For example, the transmission range set by the transmission range setting process based on the communication history as illustrated in FIG. 9 may be corrected by a result of the transmission range setting process based on the vehicle speed as illustrated in FIG. 7. In addition, the transmission range set by the transmission range setting process based on the road line shape or the road incidental item as illustrated in FIG. 6 may be corrected by a result of the transmission range setting process based on the vehicle speed as illustrated in FIG. 7.

In the above-described embodiment, the reception range of the antenna 16 may be changed according to changes in transmission range and transmission direction of the antenna 16. As a result, the communication quality of the antenna device 10 can be improved, and the power consumption of the antenna device 10 can be further reduced.

Flow of Transmission Direction Setting Process

A flow of a transmission direction setting process performed by the antenna device 10 will be described with reference to FIG. 10. FIG. 10 is a flowchart illustrating an example of a flow of a transmission direction setting process executed by the antenna device according to the embodiment.

The beam form control module 36 determines whether the radio wave transmission range is in a predetermined wide state (step S71). When the radio wave transmission range is in the predetermined wide state (step S71: Yes), the process proceeds to step S72. On the other hand, when the radio wave transmission range is not in the predetermined wide state (step S71: No), for example, when the radio wave transmission range is in a narrow state, the process returns to the main routine of FIG. 4.

When, in step S71, the radio wave transmission range is in the predetermined wide state, the transmission/reception control module 31 specifies a radio wave incoming direction (step S72). For example, the transmission/reception control module 31 specifies the radio wave incoming direction by analyzing magnitudes of signals received by the plurality of antenna elements included in each of the antennas 16a, 16b, 16c, and 16d.

The beam form control module 36 sets the radio wave transmission direction to the radio wave incoming direction specified in step S72 (step S73). For example, the beam form control module 36 sets the radio wave transmission direction by giving a phase signal corresponding to the direction in which a radio wave is to be transmitted to the plurality of antenna elements included in each of the antennas 16a, 16b, 16c, and 16d.

Furthermore, the beam form control module 36 sets the radio wave transmission range with respect to the radio wave transmission direction set in step S73 to a predetermined narrow state (step S74). Thereafter, the process returns to the main routine of FIG. 4.

Note that the antenna device 10 performs the process of FIG. 10 on each of the individual antennas 16. Furthermore, when the radio wave transmission direction is set, the beam form control module 36 may concentrate power in the transmission direction. As a result, communication quality can be improved.

Effect of Present Embodiment

As described above, an antenna device 10 according to the present embodiment for communication between vehicles, between a road and a vehicle, or between a pedestrian and a vehicle via at least one antenna 16 mounted on a vehicle 5 includes: a first detection module (a traveling place detection module 32, a vehicle state detection module 33, and/or a communication history detection module 34) that detects at least one of a traveling place, a traveling state, and a communication history of the vehicle 5; and a beam form control module 36 that sets a transmission range of a radio wave transmitted from the antenna 16 on the basis of a detection result of the first detection module. Therefore, since the transmission range of the antenna 16 can be switched at an appropriate switching trigger according to a road environment and a vehicle state, the antenna device 10 can achieve both high communication quality and low power consumption.

In addition, in the antenna device 10 according to the present embodiment, the traveling place detection module 32 (the first detection module) detects a road type of a road on which the vehicle 5 is traveling, and the beam form control module 36 sets the transmission range of the radio wave transmitted from the antenna 16 to a range according to the road type. Therefore, the transmission range of the radio wave can be set in accordance with a range in which an object that is likely to communicate with the vehicle 5 exists. As a result, the antenna device 10 can shorten a period of time for searching for a communication counterpart.

In addition, in the antenna device 10 according to the present embodiment, the traveling place detection module 32 (the first detection module) detects a road line shape or a road incidental item of a road on which the vehicle 5 is traveling, and the beam form control module 36 sets the transmission range of the radio wave transmitted from the antenna 16 to a range according to the road line shape or the road incidental item. Therefore, the antenna device 10 can set the transmission range of the radio wave to match a range in where an object or a person that may communicate with the vehicle 5 exists. As a result, the antenna device 10 can shorten a period of time to search for a communication counterpart.

In addition, in the antenna device 10 according to the present embodiment, the vehicle state detection module 33 (the first detection module) detects a vehicle speed of the vehicle 5, and the beam form control module 36 sets the transmission range of the radio wave transmitted from the antenna 16 to be narrower when the vehicle speed is equal to or higher than a threshold value than when the vehicle speed is less than the threshold value. As a result, the antenna device 10 can shorten a period of time for searching for a communication counterpart. In addition, by narrowing the transmission range of the radio wave at the time of traveling at a high speed, the power consumption of the antenna device 10 can be reduced.

In addition, in the antenna device 10 according to the present embodiment, the vehicle state detection module 33 (the first detection module) detects an inclination of the vehicle 5 in a front-rear direction that does not depend on a road shape, and the beam form control module 36 sets the transmission range of the radio wave transmitted from the antenna 16 to form a predetermined angle with respect to a road surface of a road when the inclination is equal to or larger than a predetermined value. Therefore, even if the vehicle body is inclined in the front-rear direction, radio waves can be stably transmitted and received.

In addition, in the antenna device 10 according to the present embodiment, the communication history detection module 34 (the first detection module) detects a communication history of the vehicle 5, and the beam form control module 36 sets the transmission range of the radio wave transmitted from the antenna 16 on the basis of a transmission range of a radio wave when the vehicle 5 has performed communication around the same position in the past. Therefore, when communication has been performed at the same place as in the past, the transmission range of the radio wave can be set in a short period of time.

In addition, the antenna device 10 according to the present embodiment further includes a communication state detection module 35 (a second detection module) that detects whether communication has been established with the outside of the vehicle 5, and when the communication state detection module 35 detects that communication has been established, the beam form control module 36 directs a transmission direction of the radio wave transmitted from the antenna 16 to a direction in which the communication has been established. Therefore, the power consumption of the antenna device 10 can be reduced. In addition, since power can be concentrated in the set transmission direction of the radio wave, communication quality can be further improved.

The antenna device according to the present disclosure can achieve both high communication quality and low power consumption.

The expressions “unit” and “module” used in the above-described embodiments may be replaced with other expressions such as “circuitry” or “device”.

While certain embodiments have been described, these embodiments have been presented by way of example only, and are not intended to limit the scope of the present disclosures. Indeed, the novel methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosures.

What is claimed is:

1. An antenna device mounted on a vehicle configured to communicate between the vehicle and another vehicle, between a road and the vehicle, or between a pedestrian and the vehicle via at least one antenna, the antenna device comprising:
a memory; and
a processor coupled to the memory and configured to:
detect at least one of a traveling place, a traveling state, and a communication history of the vehicle; and
set a transmission range of a radio wave transmitted from the antenna based on a detection result.

2. The antenna device according to claim 1, wherein
the processor is configured to:
detect a road type of the road on which the vehicle is traveling; and
set the transmission range of the radio wave transmitted from the antenna to a range according to the road type.

3. The antenna device according to claim 1, wherein
the processor is configured to:
detect a road line shape or a road incidental item of the road on which the vehicle is traveling; and
set the transmission range of the radio wave transmitted from the antenna to a range according to the road line shape or the road incidental item.

4. The antenna device according to claim 1, wherein
the processor is configured to:
detect a vehicle speed of the vehicle; and
set the transmission range of the radio wave transmitted from the antenna to be narrower when the vehicle speed is equal to or higher than a threshold value than when the vehicle speed is less than the threshold value.

5. The antenna device according to claim 1, wherein
the processor is configured to:
detect an inclination of the vehicle in a front-rear direction that does not depend on a road shape; and
set the transmission range of the radio wave transmitted from the antenna to form a predetermined angle with respect to a road surface of the road when the inclination is equal to or larger than a predetermined value.

6. The antenna device according to claim 1, wherein
the processor is configured to:
detect a communication history of the vehicle; and
set the transmission range of the radio wave transmitted from the antenna based on a transmission range of a radio wave when the vehicle has performed communication around a same position in past.

7. The antenna device according to claim 1, wherein
the processor is configured to:
further detect whether communication has been established with an outside of the vehicle; and
direct, in response to detecting that the communication has been established, a transmission direction of the radio wave transmitted from the antenna to a direction in which the communication has been established.

8. The antenna device according to claim 2, wherein
the processor is configured to:
further detect whether communication has been established with an outside of the vehicle; and
direct, in response to detecting that the communication has been established, a transmission direction of the radio wave transmitted from the antenna to a direction in which the communication has been established.

9. The antenna device according to claim 3, wherein
the processor is configured to:
further detect whether communication has been established with an outside of the vehicle; and
direct, in response to detecting that the communication has been established, a transmission direction of the radio wave transmitted from the antenna to a direction in which the communication has been established.

10. The antenna device according to claim 4, wherein
the processor is configured to:
further detect whether communication has been established with an outside of the vehicle; and
direct, in response to detecting that the communication has been established, a transmission direction of the radio wave transmitted from the antenna to a direction in which the communication has been established.

11. The antenna device according to claim 5, wherein
the processor is configured to:
further detect whether communication has been established with an outside of the vehicle; and
direct, in response to detecting that the communication has been established, a transmission direction of the radio wave transmitted from the antenna to a direction in which the communication has been established.

12. The antenna device according to claim 6, wherein
the processor is configured to:
further detect whether communication has been established with an outside of the vehicle; and
direct, in response to detecting that the communication has been established, a transmission direction of the radio wave transmitted from the antenna to a direction in which the communication has been established.
